(19) United States
(12) Patent Application Publication
(10) Pub. No.: US 2004/0259460 A1
(43) Pub. Date: Dec. 23, 2004

(54) Throw toy for pets

(76) Inventors: Stanley Persall SR., Port Dover (CA); Kathrine Persall, Orangeville (CA)

Correspondence Address: MILLER THOMPSON, LLP, 20 QUEEN STREET WEST, SUITE 2500, TORONTO, ON, M5H 3S1, CA

(21) Appl. No.: 10/890,164

(22) Filed: Jul. 14, 2004

Related U.S. Application Data
(63) Continuation-in-part of application No. 10/068,048, filed on Feb. 8, 2002.

(30) Foreign Application Priority Data
Feb. 16, 2001 (CA) 2,337,465
Nov. 27, 2003 (WO) PCT/CA03/01857

(51) Int. Cl. A63H 33/28

(52) U.S. Cl. 446/20

(57) ABSTRACT

A throw toy for pets comprising a generally circular top wall, presenting a generally annular sidewall diverging from said top wall; said side wall merging with a generally annular flange portion, said annular flange portion spaced from said top wall; and said annular flange portion presenting a plurality of protrusion means.

This application is a continuation-in-part of U.S. application Ser. No. 10/068,048 filed Feb. 08, 2002.

### FIELD OF INVENTION

This invention relates generally to the field of pet toys, and more particularly to a multipurpose interactive throw toy for pets.

### BACKGROUND ART

The prior art shows a number of throwable toys resembling inverted pie plates, platters, disc or saucer shaped toys for people. A flexible flying disc is described in U.S. Pat. No. 6,174,214 (Cooper). Another disc type toy is shown in U.S. Pat. No. 6,383,052 (McCarthy). Other examples of disc or saucer shaped toys can be seen in U.S. Pat. No. 5,340,347 (Yenerich); U.S. Pat. No. 5,531,624 (Dunipace) and U.S. Pat. No. 3,359,678 (Hendrick).

Use of such discs in the traditional game of “fetch” has also been popular in recreational activities involving dogs and humans. For example, U.S. Pat. No. 6,073,588 (McClung et al.) shows a throwing plate game for pets involving a flying disc. Furthermore, U.S. Pat. No. 4,919,083 (Axelrod), U.S. Pat. No. 5,261,846 (Hanna), and U.S. Pat. No. 5,078,637 (McFarland) also describe throwable pet toys in the shape of a flying disc or saucer.

One of the advantages of flying discs over other traditional fetch items such as sticks or balls is their ability to glide for substantially greater distances and thus afford a greater opportunity for cardiovascular exercise for the dog. It has been recognized by some animal behaviorists that the chasing of thrown items by dogs mimics pursuit of prey. Dogs find this pursuit and capture very satisfying.

Many dog trainers recognize the importance of interactive play between humans and dogs as a means to reinforce training. Research has demonstrated that any type of interactive object play (i.e. involving a toy) is good at developing effective relationships between man and dog. This interactive play can be in the form of fetch games, or tug games.

Toys for pets are well known in the prior art. Pet toys are commonly used in training, recreational play, exercise, and to motivate and reward pets. Pet toys come in a variety of shapes, sizes, materials, and colors.

U.S. Pat. No. 2,610,851 (Jones) shows a dog toy molded of rubber, or other resilient material, and which is formed so that either end thereof will fit into the dog's mouth. Furthermore, the process for making rubber chew toys from tire sidewalls is shown in U.S. Pat. No. 5,750,196 (Welsh) and U.S. Pat. No. 5,609,913 (Welsh). Other chewable pet toys are shown in U.S. Pat. No. 4,557,219 (Edwards), U.S. Pat. No. 4,513,014 (Edwards), and U.S. Pat. No. 4,802,444 (Markham, et al.). However, none of these toys are ideal for use as a tug toy and for use in throwing games, catching games or for use as a water and food dish.

Many dogs enjoy stuffed toys because of the association of stuffed, floppy, furry toys to prey. Many dogs find shaking stuffed animals a satisfying activity. Some animal behaviorists are of the view that this shaking is reminiscent of behaviors found in wild canines, whereby prey is shaken to break the neck or spine, thus killing the prey or effectively rendering it helpless.

Furry animal shaped, stuffed tug toys called “motivators” are used by “Agility” and “Flyball” enthusiasts to motivate and reward their dogs with tug games. (“Agility” and “Flyball” are organized competitive sports in North America whereby people and their pet dogs compete in teams).

“Tugging” generally describes the action when the animal grabs, in its mouth, an end of the toy opposite to the end in the person's hand, and the toy is then “tugged” or pulled back and forth between the animal and the person. Tugging is known to be of benefit to animals, particularly dogs. It is used in training dogs and for recreational or interactive play.

Tugging is also highly beneficial to the oral health of dogs, as it strengths teeth and jaws.

Tugging has also been used in exercise and physical therapy for animals. The action involved in tugging, exercises and strengthens various muscles in the animal, including shoulder, leg and jaw muscles. Tugging is also an effective way to massage the animal's gums. Accordingly, the use of tug toys for pets, particularly dogs, may be used in a rehabilitation or physical therapy program, in addition to training and play.

Some dogs have been selectively bred to instinctively retrieve items and present them to their human counterparts in fetch exercises. However, retrieving instinct is not present to the same extent in all dogs. A useful attractor in training dogs with minimal retrieving instincts is the use of food associated with the fetch toy as a motivator. Another useful attractor in training dogs with minimal retrieving instincts is the use of the game of tug as a motivator.

A significant drawback of traditional plastic discs (for example polyethylene, polyurethane or nylon) is their inherent degree of rigidity. They are not suitable for tug games. When plastic discs are gripped tightly enough by a dog to engage in tug play, the plastic is often punctured, producing permanent sharp protrusions that can be damaging to a dog's mouth and gums. Also, because of their relative rigidity, plastic discs are not optimum for gripping by either the dog or human counterpart in a game of tug and may in fact injure a dog's mouth when used in games of tug.

When engaging in fetch games, many dogs find it satisfying to attempt to catch the disc before it hits the ground. Plastic discs are not ideal for such exercises. Due to the relative rigidity of the material of such discs they may injure a dog if misfired (i.e. may hit the dog) or injure the mouth of the dog when the dog attempts to catch it.

Another drawback to plastic discs occurs when engaging in fetch games in cold temperatures. Many plastic discs may become brittle in cold temperature and may shatter upon impact.

Furthermore, another disadvantage of using plastic discs for fetch games with dogs is the difficulty dogs may have when picking them up. The disc as shown in Axelrod (U.S. Pat. No. 4,919,083) shows a bone shaped protuberance on the top or “up” side of the disc which is intended as a gripping device with which dogs can grasp and pick up the plastic disc. The protuberance, like the rest of the disc, is relatively rigid and smooth. Accordingly, the protuberance does not easily enable dogs to pick up the disc when the disc is such that the bone shaped protuberance is presented on the top or “up” side.

The prior art shows sewn fabric discs (Cooper: U.S. Pat. No. 6,174,214) that address some of the problems posed by rigid discs. However these discs are not optimal for tugging as they are not sufficiently puncture resistant. While no sharp permanent protrusions will occur when punctured, a dog's teeth may become caught in the puncture holes resulting in possible damage to a dog's mouth and teeth. The fabric is not sufficiently resilient or resistant to withstand the chewing or tugging by the dog, which is important for interactive games between dogs and humans.

Fabric discs are not suited for achieving distance when throwing. Due to the material and design these discs are light weight, and are not ideal for achieving maximum distance when thrown. They are also less predictable in the wind than flying discs with a heavier design.

Often fetch activities with dogs occur away from home, in open spaces such as parks or other recreational areas. Engaging in fetch activity naturally results in the dog requiring water to replenish fluids lost due to physical activity. In such instances, plastic discs can be used as portable receptacles for water. Fabric discs are not suited to be used as receptacles for water.

There is a need for an improved, more durable, more flexible, more puncture resistant throw toy for pets that may be used during training, recreational play, therapy, or exercise, and can be used as an effective tug toy.

These and other objects and advantages of the invention will become apparent from the following more detailed description, when taken in conjunction with the accompanying drawings of the illustrative embodiments.

### DISCLOSURE OF INVENTION

It is an aspect of the invention to provide a throw toy for pets that may be used for training, recreational play, physical therapy, tugging, and various other exercises or games for pets.

It is a further aspect of the invention to provide a throw toy for pets comprising of a generally circular top wall presenting a generally annular sidewall diverging from said top wall; said side wall merging with a generally annular flange portion, said flange portion spaced from said top wall; and said annular flange portion presenting a plurality of protrusion means.

It is a further aspect of the invention to provide a throw toy having mechanisms for improving grip and durability of the throw toy.

It is a further aspect of the invention to provide a throw toy for use in tugging games or tug exercises for pets.

It is yet a further aspect of the invention to provide a throw toy having teeth cleansing means.

It is yet a further aspect of the invention to provide a throw toy presenting a receptacle for retaining water and food.

It is yet another aspect of the invention to provide a throw toy that is comprised of a flexible rubber like material having fabric disposed for increasing the tensile strength and puncture resistance of said toy.

It is a further aspect of the invention to provide a throw toy made of a floatable material so that the toy floats on water.

It is a further aspect of the invention to provide a throw toy having at least one cavity thereon adapted to receive various pet treats.

It is yet a further aspect of the invention to provide a disc useful as a throwing, tugging, and chewing toy for use with pets during training, recreational play, physical therapy, or exercise, said disc comprising a circular top portion; an annular sidewall portion depending and diverging away from said top portion so as to present a conical portion; an annular flange portion merging with said annular sidewall portion; a convex outer side; a concave inner side; said annular flange portion having a plurality of stippled protrusions disposed on the surface of said flange portion; said top annular sidewall and annular flange portions being comprised of resilient material adapted for catching, chewing, shaking and tugging by said pet without harming said pet's mouth; and fabric disposed within said disc for reinforcing said disc.

It is yet a further aspect of the invention to provide a chewable and tuggable toy for pets comprising of at least one layer of rubber having at least one layer of fabric disposed throughout for reinforcing said toy.

It is a further aspect of the invention to provide a flying disc with improved distance capabilities, said disc having a greater weight than previous plastic or fabric flying discs. This additional weight or density improves the inertial energy being applied when it is thrown. Because of this additional weight or density, the invention is less effected by wind and turbulence than previous inventions.

It is a further aspect of the invention to provide a flying disc with improved flexibility and impact absorption.

It is a further aspect of the invention to provide a flying disc with improved malleability and material memory.

### BRIEF DESCRIPTION OF THE DRAWINGS

FIG. 1 is a top plan view of the throw toy;

FIG. 2 is a side cross sectional view of FIG. 1;

FIG. 3 is a top plan view of a second embodiment of the invention;

FIG. 4 is a side cross sectional view of FIG. 3;

FIG. 5 is a side cross sectional view of another embodiment of the invention having fabric disposed throughout said throw toy;

FIG. 5A is a side cross sectional view of another embodiment of the invention having two layers of fabric;

FIG. 6 is a side cross sectional view of embodiment of the throw toy having a cavity;

FIG. 7 is a side cross sectional view of yet another embodiment of the throw toy having a cavity;

FIG. 8 is a side cross sectional view of another embodiment of the throw toy;

FIG. 8A shows the embodiment in FIG. 8 wherein the sidewalls of the cavity extend down beyond the plane of the annular flange portion;

FIG. 9 is a side cross sectional view of another embodiment of the throw toy having more than one cavity;

FIG. 10 is a side cross sectional view of another embodiment of the throw toy;

FIG. 11 is a perspective view of another embodiment of the invention;

FIG. 11A is another view of the embodiment shown in the FIG. 11;

FIG. 12 is a side cross sectional view of the invention being used as a play tool;

FIG. 13 is top perspective view of another embodiment of the invention;

FIG. 14 is a side cross sectional view of another embodiment of the invention.

FIG. 15 is a side cross sectional view of another embodiment of the invention.

FIG. 16 is a side view showing a dog about to pick up the invention

FIG. 16A is a side view of a dog picking up and grasping the invention

FIG. 17 is a side view of the invention in flight

FIG. 17A is a side view of the invention upon impact with a rigid object.

### DETAILED DESCRIPTION OF THE PREFERRED EMBODIMENTS

In the description that follows, like parts are marked throughout the specification and the drawings with the same respective reference numerals. The drawings are not necessarily to scale and in some instances proportions may have been exaggerated in order to more clearly depict certain features of the invention.

This invention provides a throw toy for pets. The throw toy may be used for training, recreational play, physical therapy, tugging, and for various other exercises or games for pets. Moreover the throw toy 2 in one orientation can also be used as a bowl for the pet.

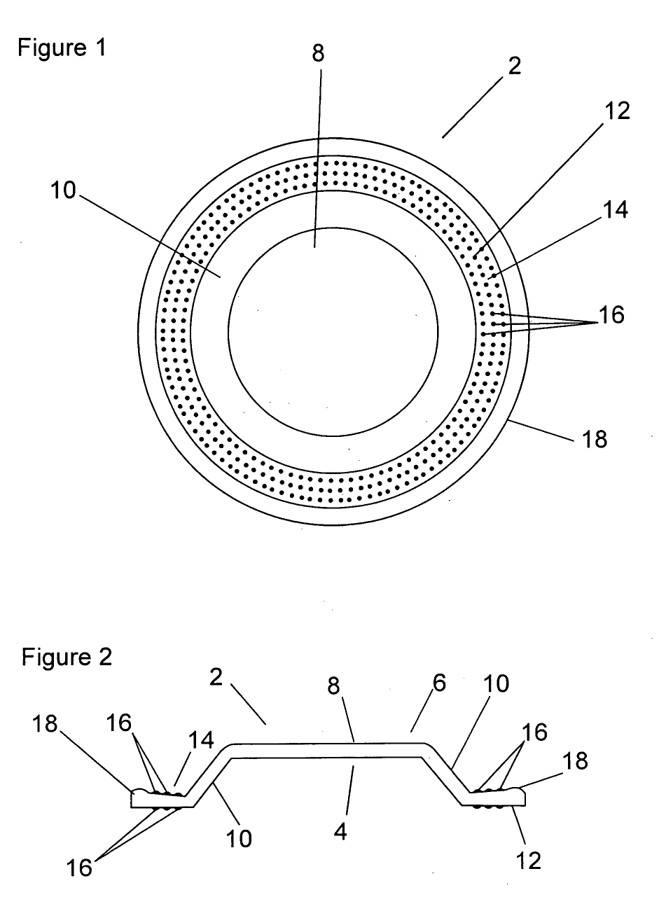

FIG. 1 is a top plan view of the throw toy 2 in accordance with the preferred embodiment. The throw toy 2 is comprised of natural and or synthetic rubber or a material having the characteristics of rubber. Furthermore, said material is soft and flexible, when compared to plastic material, and is used to protect the animal's mouth from injury which may occur if a harder material is used for the throw and catch toy 2. However, other materials may be used.

The throw toy 2 comprises of an inner side 4 and an outer side 6. The outer side 6 has a flat top wall 8 which is generally circular and presents an angled sidewall 10 extending downwardly from said flat top wall 8. The angled sidewall 10 merges with an annular flange portion 12 which extends generally radially outwardly. The annular flange 12 portion presents protrusion means 14 disposed along the periphery of annular flange portion 12.

The protrusion means 14 on the annular flange portion 12 may be comprised of a plurality of spaced apart rounded projections or raised dots that define raised stipples 16. The raised stipples 16 provide for easier and better grip of the throw toy by the thrower, particularly when the toy is wet either by water or saliva from a pet's mouth. Furthermore, the raised stipples 16 optimize the use of the throw toy for tugging games and exercises for pets.

The inclusion of the protrusion means 14 and/or the raised stipples 16 on the throw toy 2 provides many benefits for tugging or chewing by the animal. For example, the raised stipples 16 provide for better grip of the throw toy 2 in the animal's mouth, and aid in cleaning and massaging of the teeth and gums of the animal. In other words, the raised dots or stipples 16 help clean tartar from the pet's mouth. The soft and flexible material of the throw toy 2 combined with the raised stipples 16 makes the throw toy 2 an ideal toy for tugging and chewing.

The raised stipples 16 may be arranged annularly in at least one row on the surface of the annular flange portion 12 on one or both sides of throw toy.

When the raised stipples 16 are disposed on the inner side 4 of the throw toy 2 this, along with the rubber like material of the throw toy 2, increases the amount of friction between the toy 2 and a smooth surface when the toy is being moved across said smooth surface. Therefore the tendency of the throw toy 2 to glide or slide across a smooth surface, such as floors or asphalt is reduced. The reduced ability to slide allows the animal to pick up the throw toy 2 easier than prior art devices.

FIG. 2 is a side elevational view of the throw toy 2 in accordance with another embodiment. The annular flange portion 12 of the throw toy 2 presents an outer annular rim 18. The outer annular rim 18 extends generally radially and axially from the annular flange portion 12. In other words, the outer rim is flared upwards, or enlarged, on the outer side 6 of the throw toy 2.

The flared outer annular rim 18 provides increased thickness around the periphery of the toy 2 for better grip of the throw toy 2 by the thrower and better grip of the throw toy 2 in the animal's mouth. The outer annular rim 18 also provides increased durability for the throw toy 2. The position of the outer annular rim 18 along the periphery of the throw toy 2 is the position which is most often chewed by the animal and subjected to the most wear and tear. Since the outer annular rim 18 is generally thicker than the annular flange portion 12, it is more durable than the other positions of the throw toy 2 and it can withstand more chewing than other areas of the throw toy 2. Alternatively, the lower or both upper and lower portion of the outer annular rim is enlarged or flared.

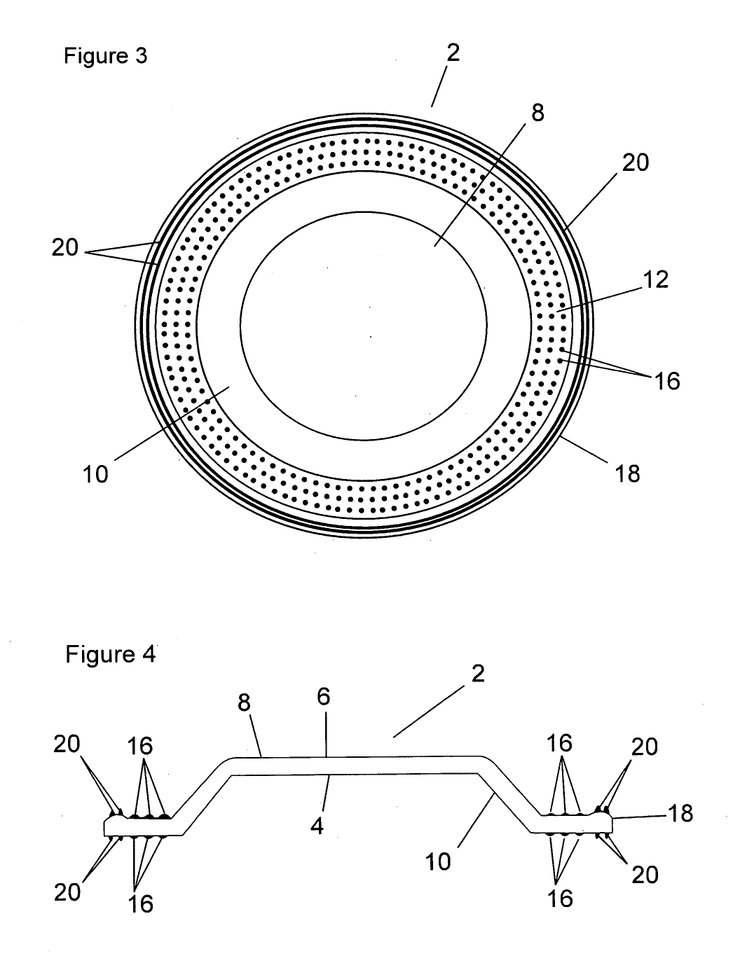

Another embodiment of the invention is shown in FIG. 3. In this embodiment, the throw toy 2 presents an annular rib 20 along the periphery of said annular flange portion 12. The protrusion means 14 may comprise the annular rib 20. The annular rib 20 may be disposed on either the inner side 4, the outer side 6, or both the inner side 4 and the outer side 6. The throw toy 2 may have more than one annular rib 20.

The annular rib 20 aids in gripping of the throw toy 2 by humans, particularly when the throw toy 2 is wet. The annular rib 20 reduces the likelihood of the throw toy 2 slipping out of the human hand. Furthermore, the annular rib 20 is beneficial for the oral care and oral hygiene of pets, as the annular rib 20 acts as a teeth cleaning and gum massaging mechanism for pets.

FIG. 4 is a side cross sectional view of FIG. 3 showing the throw toy 2 having two annular ribs 20 on both the inner side 4 and outer side 6. Furthermore, the protrusion means 14 comprised of raised stipples 16 are also shown on the inner side 4 and the outer side 6 of the throw toy 2.

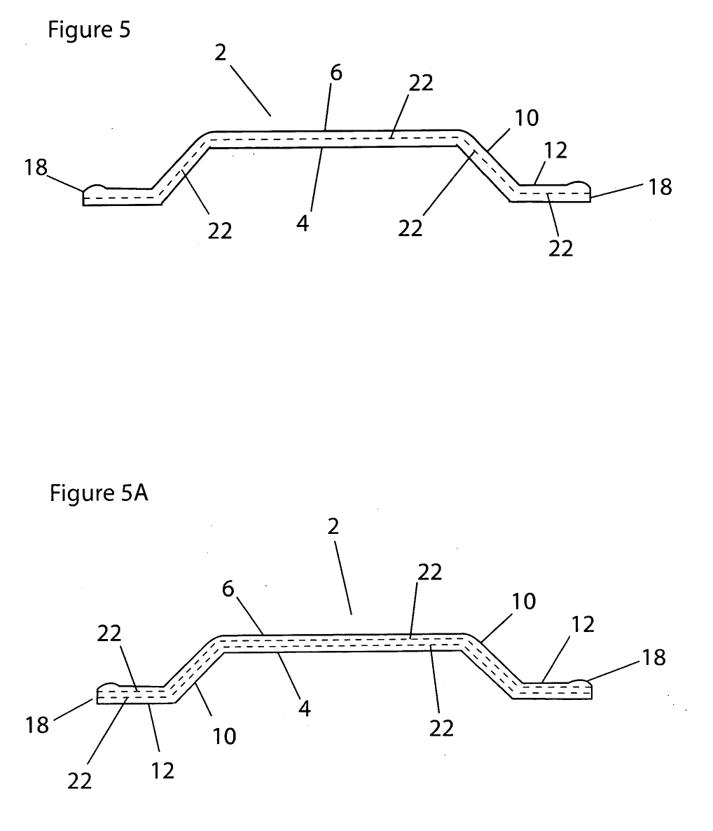

FIG. 5 shows the throw toy 2 having fabric 22 disposed interiorly for reinforcing the throw toy 2. The throw toy 2 may have more than one layer of fabric material 22 disposed throughout the throw toy 2, as shown in FIG. 5A. The fabric 22 may be flexible woven fabric or meshed fabric or other fabric. Having the fabric 22 disposed between the layers of the material of the throw toy 2 increases the strength and flexibility of the throw toy 2 and resists tearing and puncturing particularly when the throw toy 2 is being tugged by a pet. Furthermore, the reinforced throw toy 2 is more durable and better at absorbing impact energy.

During the manufacturing stage, uncured rubber is applied to one of the flat surfaces of the fabric 22 Thereafter another layer of uncured rubber is applied to the other flat surface of the fabric 22 and then molded into shape and vulcanized. The fabric permits the vulcanized rubber to seep through the fabric 22 to bond to the outer layer of rubber to produce a strong unified throw or tug toy 2 with improved tensile properties.

The fabric 22 between the various layers also enables rubber with different properties to be combined to produce various visual and physical effects. In other words one layer of rubber can have a high concentration of carbon to increase its strength while another layer has a different strength, color characteristic, or specific gravity. The rubber having the higher concentration of carbon is generally black in color. FIG. 5A shows that two spaced layers of fabric can be used with the layers of rubber. Any number of layers can be used.

The fabric 22 between the layers of rubber can be used to reinforce toys for pets of various shapes, designs and sizes to increase the durability and flexibility and tensile strength of the toys, particularly toys for tugging and chewing. The fabric between the layers of rubber allows for different shaped toys that are effective as tug and chew toys without being as thick and or heavy as traditional rubber dog toys and thus more suited as throw toys. For example, the boomerang shaped toy 1 shown in FIG. 13 shows the fabric 22 being disposed throughout the boomerang toy 1 between the layers of rubber 7. The boomerang shaped toy 1 is comprised of a substantially flat planar device having two curved winged portions 3 and 5 along the end thereof. The boomerang toy 1 is substantially flexible.

Furthermore, the fabric 22 being disposed between layers of rubber 7 could also be used in toys of various other shapes including non flying or non disc type toys for pets.

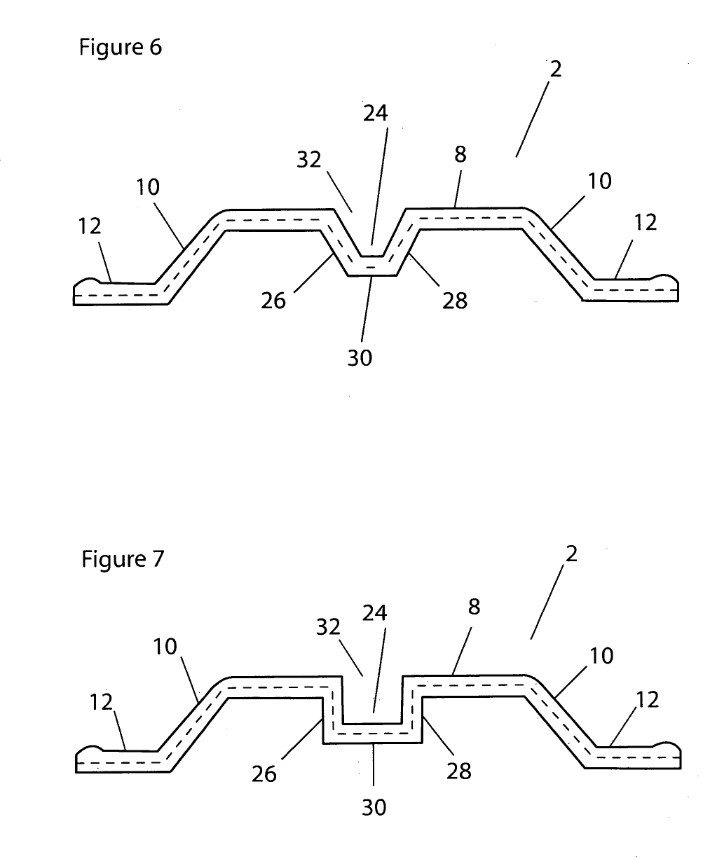

Another embodiment of the invention is shown in FIG. 6. The throw toy 2 shown in the figure has a flat top wall 8 on the outer side 6 having a cavity 24 therein. The cavity 24 is defined by an opening 32, cavity sidewalls 26 and 28 and a cavity bottom wall 30. The cavity sidewalls 26 and 28 may taper downwardly towards the bottom wall 30 as shown in FIG. 6. Alternatively, the cavity sidewalls 26 and 28 may descend generally straight down from the flat top wall 8 as shown in FIG. 7.

The cavity 24 of the flat top wall 8 of the throw toy 2 is adapted to receive various types and consistencies of dog treat such as smearable food and or biscuits. Smearable food includes foods such as peanut butter, cheese spread, or the like. Biscuits for dogs are popular and available in various shapes and sizes. The invention has sufficient flexibility such that the cavity sidewalls 26 and 28 stretch sufficiently to firmly lodge hard biscuits within the cavity 24.

The throw toy 2 having a cavity or pocket 24 with smearable or solid food inside can be used as a motivational toy or reward. For example, it can be used when training retrieval skills to animals, particularly dogs. The throw toy 2 can be thrown by the human and when it is retrieved by the pet, the pet is rewarded by the food.

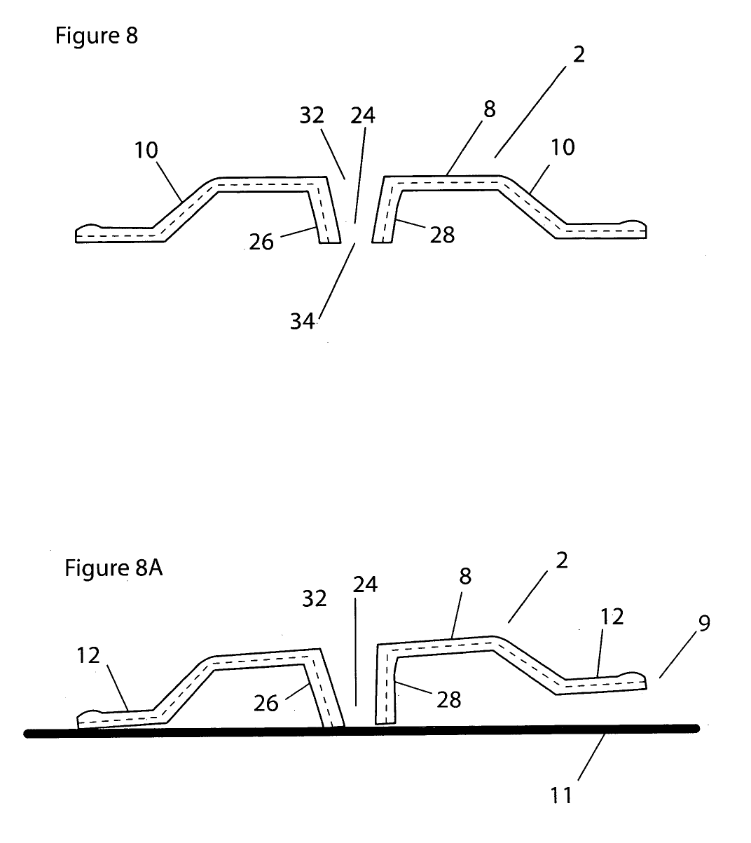

FIG. 8 shows the throw toy 2 having a cavity 24 in the flat top wall 8 wherein the bottom wall 30 of the cavity 24 is removed so as to present a hole 34 therethrough. The hole 34 is adapted to receive a toy or solid or spreadable food for the pet.

In FIG. 8A the cavity sidewalls 26 and 28 extend down beyond the plane of the annular flange portion 12 causing one edge 9 to be displaced from a surface 11. This makes it easier to pick up the throw toy 2.

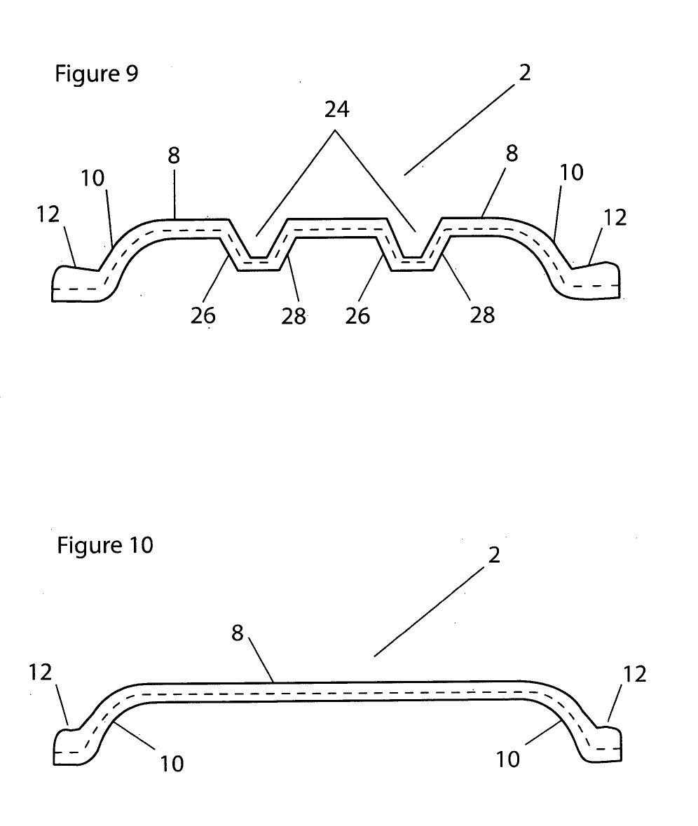

The throw toy 2 can have more than one cavity 24 on the flat top wall 8, as shown in FIG. 9. The cavities 24 are adapted to receive solid or smearable food. This throw toy 2 is useful as a toy for training and motivational games for pets.

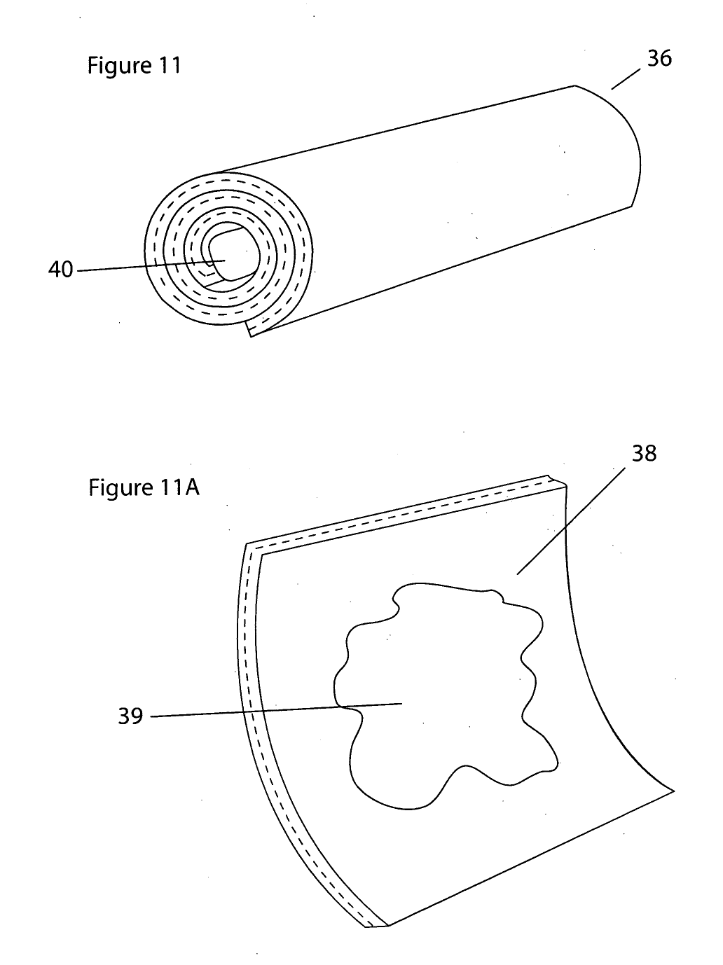

FIG. 10 shows another embodiment of the throw toy 2 whereby the convexity of the flat top wall 8 is much broader than the other embodiments described such that this embodiment resembles a traditional flying disc such as a Frisbee™. This embodiment provides a throw toy 2 with different aerodynamic qualities than the other embodiments when thrown. The embodiment of the throw toy 2 shown in FIG. 10 may be made with or without the outer annular rim 18.

FIG. 11 shows another embodiment of the invention, namely a chewable throwable toy simulated baton 36 for pets. The chewable throwable toy baton 36 is comprised of a generally planar surface 38 and is made of a rubber like material to provide for a flexible and durable toy. The planar surface 38 has a memory and is biased to present a coiled configuration in cross section, as shown in FIG. 11. This coiled configuration is suitable for tossing. The planar surface 38 is adapted to receive smearable food, such as peanut butter, cheese spread or the like, 39 as shown in FIG. 11A. When the throwable toy baton 36 is in a coiled configuration it is adapted to receive solid biscuit treats 40. The rolled baton 36 may be unrolled to spread peanut butter along one side. Upon releasing the baton 36 the memory of the toy baton 36 will cause the material to roll up upon itself. The baton 36 can be reinforced by fabric to resist tearing and puncturing.

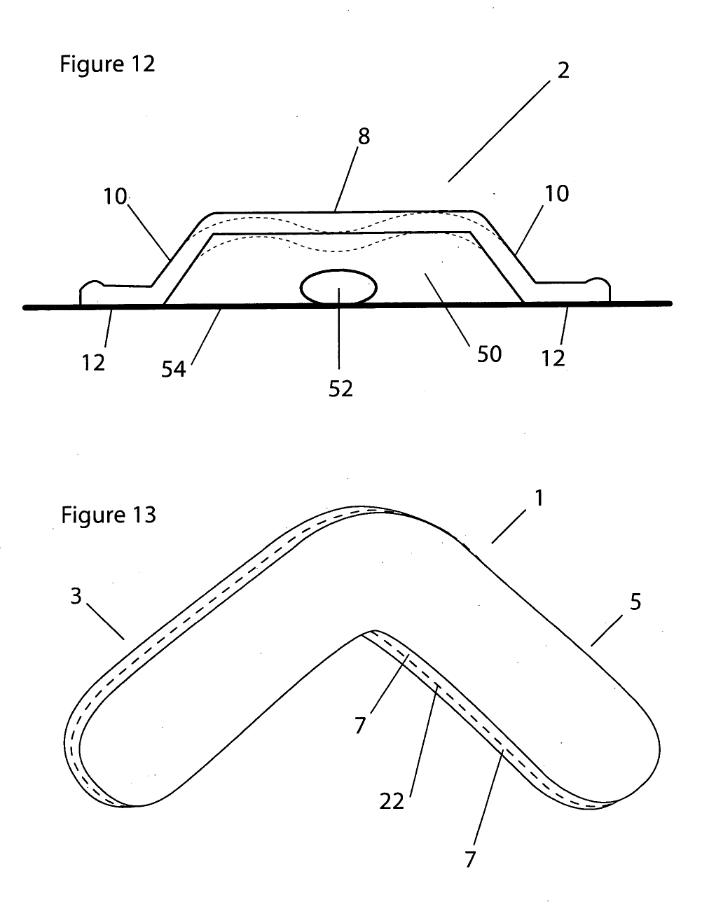

FIG. 12 shows the throw toy 2 being used in a game where the throw toy 2 is covering a treat for the pet. The top wall 8 can be depressed against a smooth surface 54 to evacuate air within the cavity 50 containing the treat 52. Since the lower surface of annular flange portion 12 is comprised of rubber, a vacuum is created which tends to cause the throw toy 2 to stick to the smooth surface 54 by suction. The pet will attempt to bite the top of the throw toy 2 to get at the treat 52.

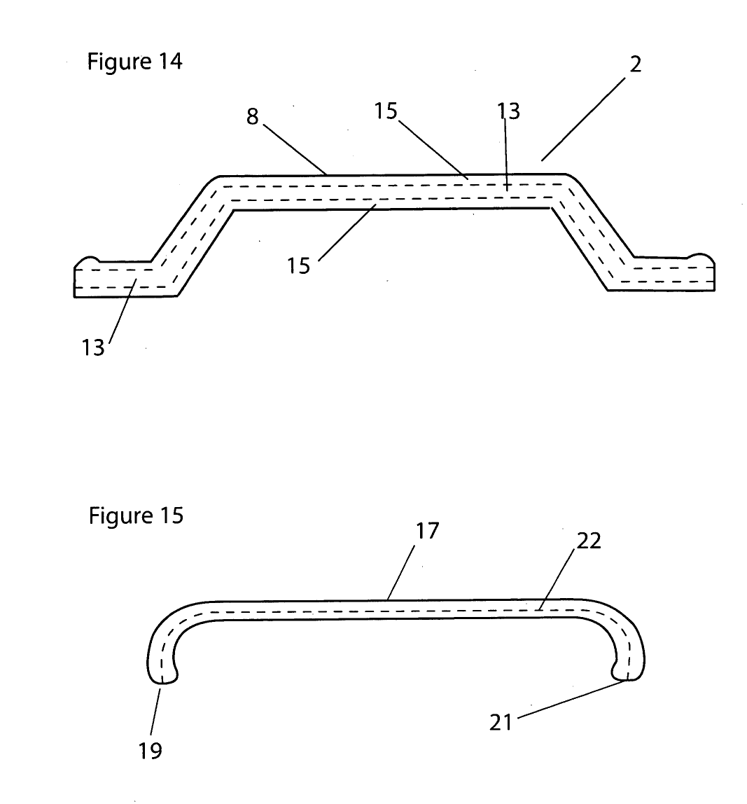

The throw toy 2 may be comprised of a material which is floatable on water, as shown in FIG. 14. The throw toy 2 is comprised of at least one low density rubber layer 13 that is surrounded by two or more layers of higher density rubber 15 as shown in FIG. 14. The layer of lower density rubber 13 offsets the higher density rubber layers 15 resulting in the specific gravity of the throw toy 2 being less than 1. Alternatively, the density of the rubber layers 15 can be selected to provide certain physical characteristics. For example, a higher concentration of carbon will increase the strength of such layer.

FIG. 15 shows another embodiment of the invention having a generally circular body 17 and edges 19 and 21 which extend downwards of the circular body 17. The fabric 22 is disposed throughout the generally circular body 17 and extends to the edges 19 and 21.

The throw toy 2 may also be comprised of a material which is dishwasher safe. This provides the benefit of optimal cleaning conditions for the throw toy.

Furthermore, the throw toy 2 may be of one solid colour, or two or more colours. Having more than one colour improves the aesthetic appearance of the throw toy 2.

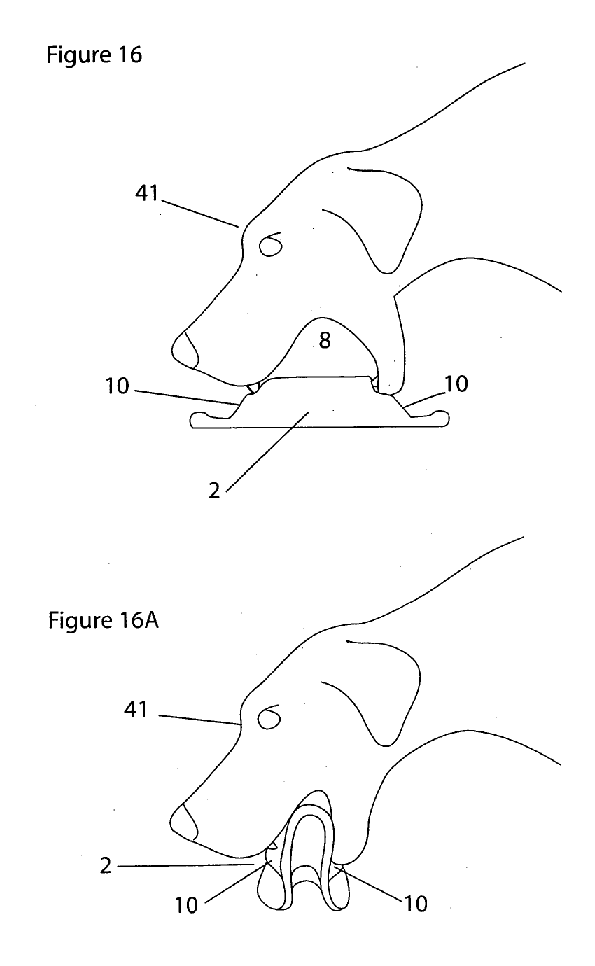

The throw toy 2 can be made in various sizes. FIG. 16 shows the throw toy 2 whereby the radius of the flat top wall 8 is proportionate to the size of the pet 41 so as to enable the pet's mouth to engage the flat top wall 8 to make it easier for the pet 41 to lift the throw toy 2 with its mouth. FIG. 16A shows the throw toy 2 is easily capable of being folded in the mouth of the pet 41 such that opposite ends of the annular flange portion 10 tend to meet. This activity is facilitated by the invention described herein over the more rigid plastic prior art devices described above. Furthermore upon release of the throw toy 2, the memory in the throw toy 2 will cause the throw toy 2 to spring back into its original shape.

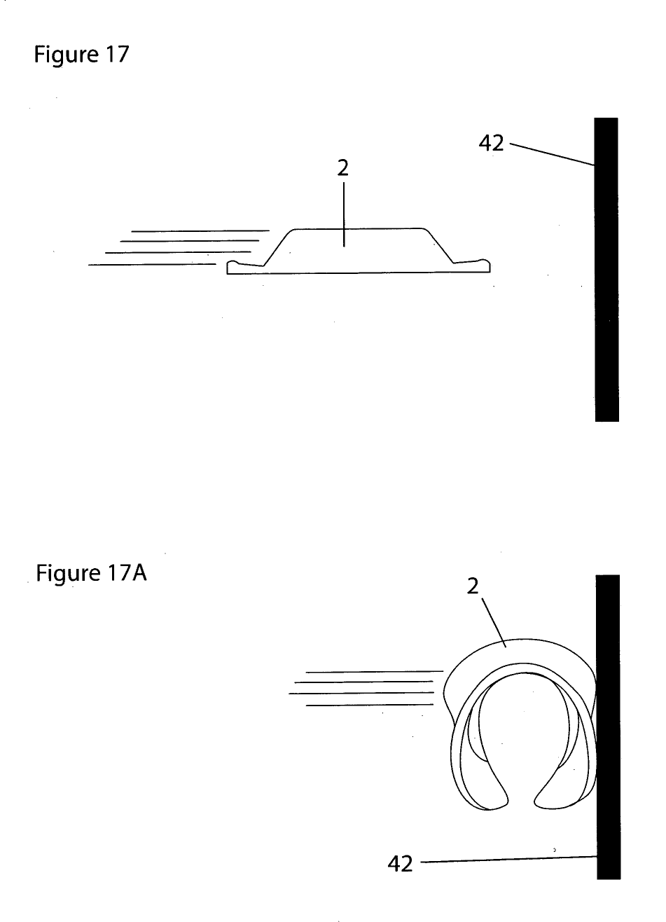

FIG. 17 shows the throw toy 2 approaching a wall or other rigid surface 42 at speed during flight. FIG. 17a shows the throw toy 2 collapsing upon impact and absorbing impact energy.

The throw toy 2 can also be used as an effective water or food dish for a pet when the throw toy 2 is placed in an inverted position having the inner side 4 of the throw toy 2 exposed.

In addition to use of the throw toy 2 in interaction between humans and animals, the throw toy 2 can also be used by pets, particularly dogs, in independent play. Most dogs have natural predatory instincts and for this reason often engage in independent play with toys such as stuffed animals to mimic prey. These toys are generally made of fabric material only and can tear easily. The throw toy 2 as described is made from a rubber like material, with fabric 22 disposed within the material, which is far more durable, and lasts longer.

Various embodiments of the invention have now been described in detail.

Since changes in and/or additions to the above-described best mode may be made without departing from the nature, spirit or scope of the invention, the invention is not to be limited to said details.

I claim:

1. A throw toy for pets comprising:
(a) a generally circular top wall, presenting a generally annular sidewall diverging from said top wall;
(b) said side wall merging with a generally annular flange portion, said annular flange portion spaced from said top wall; and
(c) said annular flange portion presenting a plurality of protrusion means.

2. A throw toy as claimed in claim 1 wherein said plurality of protrusion means is comprised of a plurality of spaced generally circular protrusions.

3. A throw toy as claimed in claim 1 wherein said plurality of protrusion means comprises a plurality of stippled protrusions disposed in an annular disposition on said annular flange portion.

4. A throw toy as claimed in claim 1 wherein said annular flange portion presents an outer annular rim extending generally radially and axially from said flange portion.

5. A throw toy as claimed in claim 1 wherein said throw toy presents one or more annular ribs along the periphery of said annular flange portion on at least one side of the throw toy.

6. A throw toy as claimed in claim 3 wherein said stippled protrusions are arranged annularly on the surface of said annular flange portion on at least one side of said throw toy.

7. A throw toy as claimed in claim 1 comprised of rubber.

8. A throw toy as claimed as 1 wherein said toy is composed of one or more layers of a rubber having at least one layer of fabric material disposed throughout said toy for increasing the strength, flexibility and impact absorption ability of said toy.

9. A throw toy as claimed in claim 1 wherein said throw toy is made from a material which is floatable on water.

10. A throw toy as claimed in claim 1 wherein said flat top wall has at least one cavity therein.

11. A throw toy as claimed in claim 10 wherein said cavity is defined by cavity sidewalls and a bottom wall.

12. A throw toy as claimed in claim 11 wherein said cavity sidewalls extend down beyond the plane of the annular flange portion.

13. A throw toy as claimed in claim 10 wherein said cavity is adapted to receive smearable food.

14. A throw toy as claimed in claim 11 wherein said cavity sidewalls taper downwardly towards the bottom wall.

15. A throw toy as claimed in claim 10 wherein said cavity is adapted to receive solid food.

16. A throw toy as claimed in claim 11 wherein said bottom wall is removed so as to present a hole therethrough.

17. A throw toy as claimed in claim 16 wherein said hole is adapted to receive a play toy or food.

18. A chewable toy baton for pets comprising of a generally planar surface, said planar surface being memory biased to present a coiled configuration in cross section.

19. A chewable toy baton for pets as claimed in claim 18 wherein said planar surface is adapted to receive smearable food.

20. A chewable toy baton as claimed in claim 18 adapted to receive solid food or a toy in the centre of said coiled configuration.

21. A disc useful as a throwing, tugging, and chewing toy for use with pets during training, recreational play, physical therapy, or exercise, said disc comprising:
(a) a circular top portion;
(b) an annular sidewall portion depending and diverging away from said top portion so as to present a conical portion;
(c) an annular flange portion merging with said annular sidewall portion;
(d) a convex outer side;
(e) a concave inner side;
(f) said annular flange portion having a plurality of stippled protrusions disposed on the surface of said flange portion;
(g) said top annular sidewall and annular flange portions being comprised of resilient material adapted for chewing and tugging by said pet without harming said pet's mouth; and
(h) fabric disposed within said disc for reinforcing said disc.

22. A disc as claimed in claim 21 wherein said resilient material is rubber.

23. A chewable and tuggable toy for pets comprising of at least one layer of rubber having at least one layer of fabric disposed throughout for reinforcing said toy.
